(19) United States
(12) Patent Application Publication
(10) Pub. No.: US 2005/0238948 A1
(43) Pub. Date: Oct. 27, 2005

(54) Anode for liquid fuel cell, membrane electrode assembly for liquid fuel cell, and liquid fuel cell

(76) Inventors: Wu Mei, Yokohama-shi (JP); Yoshihiro Akasaka, Kawasaki-shi (JP); Maki Yonetsu, Mitaka-shi (JP); Yoshihiko Nakano, Yokohama-shi (JP); Hideyuki Ohzu, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/113,999

(22) Filed: Apr. 26, 2005

(30) Foreign Application Priority Data
Apr. 26, 2004 (JP) 2004-129841

(51) Int. Cl. H01M 8/00

(52) U.S. Cl. 429/40; 429/235; 429/12

(57) ABSTRACT

An anode for liquid fuel cell includes a current collector and a catalyst layer, in which the catalyst layer has a porosity in a range of 20 to 65%, and a volume of pores of which diameter ranges from 50 to 800 nm is 30% or more of a pore volume of the catalyst layer, the catalyst layer has a pore diameter distribution having a peak in a range of 100 to 800 nm, and the catalyst layer comprises fibrous supported catalysts and granular supported catalysts, the fibrous supported catalysts contain carbon nanofibers having a herringbone or platelet structure, and catalyst particles carried on the carbon nanofibers, and the granular supported catalysts contain carbon black particles and catalyst particles carried on the carbon black particles.

### CROSS-REFERENCE TO RELATED APPLICATIONS

This application is based upon and claims the benefit of priority from prior Japanese Patent Application No. 2004-129841, filed Apr. 26, 2004, the entire contents of which are incorporated herein by reference.

### BACKGROUND OF THE INVENTION

1. Field of the Invention

The present invention relates to an anode for liquid fuel cell, a membrane electrode assembly for liquid fuel cell, and a liquid fuel cell.

2. Description of the Related Art

A fuel cell electrochemically oxidizes a fuel such as hydrogen or methanol within the cell, and thereby converts a chemical energy of the fuel directly into an electrical energy. Such a fuel cell is expected as a clean electrical energy supply source because NOx or SOx is not generated by combustion of the fuel. In particular, a direct methanol fuel cell (DMFC) can be reduced in size and weight as compared with other fuel cells such as a polymer electrolyte fuel cell (PEMFC) using hydrogen as a fuel, and the DMFC is intensively studied recently as a power source for personal digital assistant such as a notebook computer or a cellphone.

A membrane electrode assembly (electromotive force unit) of the direct methanol fuel cell (DMFC) includes an anode current collector, an anode catalyst layer, a proton conductive layer, a cathode catalyst layer, and a cathode current collector, as shown in FIG. 1. The current collector is a porous conductive material. The current collector also plays a role of supplying a fuel or oxidizer to the catalyst layer, and thus is also known as a diffusion layer. The catalyst layer is formed of a porous layer containing, for example, a catalyst active substance, a conductive substance, and a proton conductive material. In the case of using a conductive substance as supports for the catalysts, the catalyst layer is often a porous layer containing supported catalysts and a proton conductive material. An electrode usually includes two parts: the catalyst layer and the diffusion layer. The anode and cathode may be called a fuel electrode and an oxidizer electrode, respectively.

When methanol aqueous solution is supplied to the anode catalyst layer, and air (oxygen) is supplied to the cathode catalyst layer, catalytic reactions of formula (b 1) and formula (2) take place in each electrode.
Fuel electrode: CH₃OH+H₂O→CO₂+6H⁺+6e⁻ (1)
Oxidizer electrode: 6H⁺+(3/2)O₂+6e⁻→3H₂O (2)

Protons and electrons generated in the fuel electrode move to the oxidizer electrode via proton conductive membrane and the anode current collector, respectively. In the oxidizer electrode, the electrons and the proton react with oxygen, and thus current occurs between a pair of current collectors. Excellent cell performance require smooth supply of an adequate quantity of fuel to the electrodes, quick and abundant generation of electrode catalytic reaction in the triple phase boundaries of fuel-catalyst-electrolyte. And the cell performance further requires smooth movement of the electron and proton, and quick discharge of the reaction product. The anode is desired to have a structure capable of promoting diffusion of the fuel and CO₂. In the case of DMFC, however, there is a crossover phenomenon of passing of the fuel from the fuel electrode to the oxidizer electrode, which does harm to the cathode catalyst layer and catalytic reaction and deteriorate the cell performance. Therefore, it is hard to obtain excellent cell performance only by the smooth diffusion of the fuel and CO₂ into the catalyst layer. It is hence desired to have an anode catalyst layer capable of improving the diffusion and suppressing crossover at the same time.

The anode of the existing DMFC is generally obtained by forming a slurry mixture of granular catalysts or supported catalysts and a proton conductive material on a carbon paper (anode current collector) or a proton conductive layer by a coating method, a transfer method, a spray method or the like. This structure is substantially same as the generally used anode for PEMFC. The catalyst layer thus formed is dense and poor in supply of a liquid fuel, and therefore, sufficient cell performance is not obtained even if a large amount of catalyst is used.

As for the optimum anode catalyst layer, it is widely studied in the PEMFC, which has been expected to be applied in a fuel cell for automobile and a stationary fuel cell. For enhancement of gas permeability, attention is paid to optimization of the electrode porous structure, in particular, to control of the pore diameter. Various techniques are devised and disclosed, for example, a fibrous supports is introduced, supports is changed, different supports are mixed, or a pore forming agent is introduced. These techniques are not sufficient. Further, the fuel diffusion of a methanol liquid fuel is extremely slow as compared with a hydrogen fuel, and the crossover is extremely large, so that it is hard to apply these results in DMFC. Actually, to optimize the anode of DMFC, techniques similar to those of PEMFC, such as optimization of porosity and pore size, have been attempted. For example, in Jpn. Pat. Appln. KOKAI Publication No. 2003-200052, fibers of different diameter distribution are used, thin fibers are used as a catalyst supports, thick fibers and thin fibers are mixed, pore distributions of two types are formed, and the porous structure is optimized. Jpn. Pat. Appln. KOKAI Publication No. 2003-200052 also proposes a technology of decreasing the crossover by joining a coarse catalyst layer of fibrous supported catalysts and a dense catalyst layer of granular supported catalysts.

### BRIEF SUMMARY OF THE INVENTION

It is an object of the invention to provide an anode for liquid fuel cell capable of satisfying both diffusion of a liquid fuel and crossover suppression of the liquid fuel, a membrane electrode assembly for liquid fuel cell including the anode, and a liquid fuel cell including the anode.

According to a first aspect of the present invention, there is provided an anode for liquid fuel cell, comprising a current collector, and a catalyst layer formed on the current collector,

wherein the catalyst layer has a porosity in a range of 20 to 65%, a volume of pores of which diameter ranges from 50 to 800 nm is 30% or more of a pore volume of the catalyst layer,

the catalyst layer has a pore diameter distribution having a peak in a range of 100 to 800 nm, and

the catalyst layer comprises fibrous supported catalysts and granular supported catalysts, the fibrous supported catalysts contains carbon nanofibers having a herringbone or platelet structure, and catalyst particles supported on the carbon nanofibers, and the granular supported catalysts contains carbon black particles and catalyst particles supported on the carbon black particles.

According to a second aspect of the present invention, there is provided a membrane electrode assembly for liquid fuel cell, comprising an anode, a cathode, and a proton conductive layer provided between the anode and the cathode,

wherein the anode comprises a current collector, and a catalyst layer provided on the current collector,

the catalyst layer has a porosity in a range of 20 to 65%, a volume of pores of which diameter ranges from 50 to 800 nm is 30% or more of a pore volume of the catalyst layer,

the catalyst layer has a pore diameter distribution having a peak in a range of 100 to 800 nm, and

the catalyst layer comprises fibrous supported catalysts and granular supported catalysts, the fibrous supported catalysts contain carbon nanofibers having a herringbone or platelet structure, and catalyst particles carried on the carbon nanofibers, and the granular supported catalysts contain carbon black particles and catalyst particles carried on the carbon black particles.

According to a third aspect of the present invention, there is provided a liquid fuel cell comprising an anode, a cathode, a proton conductive layer provided between the anode and the cathode, and a liquid fuel to be supplied to the anode,

wherein the anode comprises a current collector, and a catalyst layer provided on the current collector,

the catalyst layer has a porosity in a range of 20 to 65%, a volume of pores of which diameter ranges from 50 to 800 nm is 30% or more of a pore volume of the catalyst layer,

the catalyst layer has a pore diameter distribution having a peak in a range of 100 to 800 nm, and

the catalyst layer comprises fibrous supported catalysts and granular supported catalysts, the fibrous supported catalysts contain carbon nanofibers having a herringbone or platelet structure, and catalyst particles carried on the carbon nanofibers, and the granular supported catalysts contain carbon black particles and catalyst particles carried on the carbon black particles.

### BRIEF DESCRIPTION OF THE SEVERAL VIEWS OF THE DRAWING

FIG. 1 is a schematic sectional view showing an embodiment of a membrane electrode assembly in a liquid fuel cell of the invention;

FIG. 2 is a schematic view showing a microstructure of a catalyst layer of an anode according to one embodiment of the invention;

FIG. 3 is a characteristic view showing pore distribution in accordance with a mercury porosimetry method in an anode for liquid fuel cell according to a first embodiment of the invention; and

FIG. 4 is a transmission electron microscope (TEM) micrograph of a section cut along the thickness direction of a catalyst layer of the anode for liquid fuel cell according to the first embodiment.

### DETAILED DESCRIPTION OF THE INVENTION

The fuel cell disclosed in Jpn. Pat. Appln. KOKAI Publication No. 2003-200052 does not have sufficient countermeasure, and there is still a room for improvement. In particular, different from the PEMFC, in the case of DMFC, aside from the optimum porous structure, affinity of the methanol-containing liquid fuel and the catalyst layer seems to have effects on improvement of diffusion of the liquid fuel and CO₂ and crossover suppression. For example, diffusion of the liquid fuel on the surface of catalyst fine particles is estimated to be related not only with the pore size and pore distribution, but also with the surface structure of the supported catalystsurface chemical property, and a coating state of the proton conductive substance on the supported catalystsurface. To realize an optimum catalyst layer, it seems necessary to optimize constituent materials of the catalyst layer, composition ratio of the constituent materials, and a fabricating method aside from optimization of the porous structure such as pore distribution.

In order to achieve the above object, the invention has been completed as a result of intensive studies about optimization of a catalyst layer. The present inventors have obtained an optimum pore structure for satisfying both liquid fuel diffusion and crossover suppression by controlling pore distribution with mixture of different supported catalysts. From the fibrous supported catalysts and granular supported catalysts, one having affinity for the fuel is selected. As a result, a catalyst layer structure capable of satisfying both diffusion improvement of the liquid fuel and fuel crossover suppression can be realized, and a fuel cell having excellent cell performance can be provided.

That is, an anode for liquid fuel cell according to an embodiment of the invention includes a current collector, and a catalyst layer formed on the current collector. The catalyst layer has a porosity in a range of 20 to 65%, and a volume of pores of which diameter ranges from 50 to 800 nm being 30% or more of the total pore volume of the catalyst layer. The catalyst layer has a pore diameter distribution having a peak in a range of 100 to 800 nm. The catalyst layer includes fibrous supported catalysts and granular supported catalysts. The fibrous supported catalysts contain carbon nanofibers having a herringbone or platelet structure, and catalyst particles carried on the carbon nanofibers. On the other hand, the granular supported catalysts contain carbon black particles and catalyst particles carried on the carbon black particles.

The anode is preferred to have a pore diameter decreasing structure in which a pore diameter of the catalyst layer becomes smaller from the first surface of the catalyst layer facing the current collector to the second surface of the catalyst layer on the opposite side along the thickness direction of the catalyst layer. At this time, more preferably, the average decreasing rate of the pore diameter per 1 μm of thickness of the catalyst layer should be 5 to 20 nm.

As the liquid fuel, a fuel containing methanol and water may be used. The liquid fuel containing methanol and water is, for example, an aqueous methanol solution.

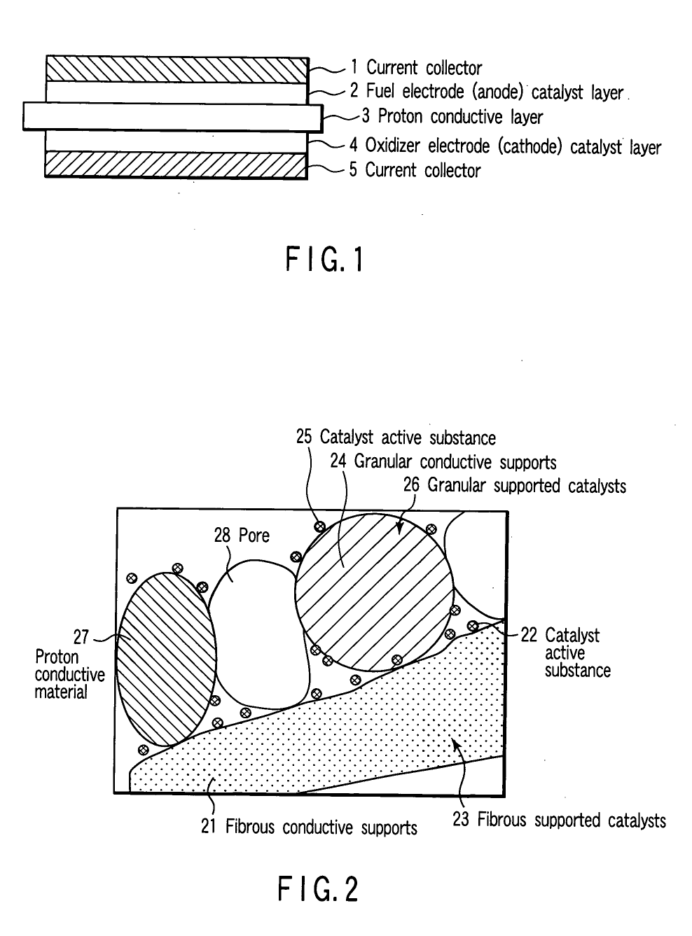

FIG. 1 shows a basic structure of a membrane electrode assembly of a direct methanol fuel cell (DMFC) as an embodiment of the liquid fuel cell.

The membrane electrode assembly (electromotive force unit) includes an anode current collector 1, an anode catalyst layer (catalyst layer) 2, a proton conductive layer 3, a cathode catalyst layer 4, and a cathode current collector 5 in this sequence.

A porous structure of the anode catalyst layer will be explained.

The invention has realized a catalyst layer having proper pore distribution by mixing fibrous supported catalysts and granular supported catalysts. The fibrous supported catalysts comprise preferably nanofibers having an average aspect ratio of 10 or more as supports, with catalyst particles carried thereon. The average aspect ratio of the fibrous supported catalysts are an average fiber length with an average fiber diameter supposed to be 1. The granular supported catalysts comprise preferably fine particles having an average aspect ratio of 4 or less as supports, with catalyst particles carried thereon. More preferably, the average aspect ratio is 2 or less. preferred such the porosity is 30 to 55%. The average aspect ratio of the granular supported catalysts are an average longer diameter of particles with an average shorter diameter of particles supposed to be 1. The average diameter of the fibrous supported catalysts are defined to be an average primary particle diameter thereof. And, the average diameter of the granular supported catalysts are defined to be an average primary particle diameter thereof. The fibrous supported catalysts can play a role of forming a skeleton in the catalyst layer, and the granular supported catalysts are high in shape adaptability and fluidity, and can play a role of filling up a space in the skeleton. Long fibrous supported catalysts or a proton conductive substance covered on a surface of the catalyst may also play a role of promoting electron conduction and proton conduction in the catalyst layer. Various porous structures may be designed by selection of the fibrous supported catalysts and granular supported catalysts, and adjustment of a blending ratio.

FIG. 2 is an enlarged view schematically showing the anode catalyst layer 2 (catalyst layer) used in the invention. The anode catalyst layer 2 is a porous layer comprising fibrous supported catalysts 23, granular supported catalysts 26 and a proton conductive material 27. The fibrous supported catalysts 23 contain fibrous conductive supports 21 and platinum alloy fine particles (catalyst active substance) 22. The granular supported catalysts 26 contain granular conductive supports 24 and platinum alloy fine particles (catalyst active substance) 25. Size and distribution of pores (gaps) 28 of the anode catalyst layer 2 can be determined by a large skeleton formed by the fibrous supported catalysts 23, a size, an amount and an aggregation state of the granular supported catalysts 26 filled therein, an amount of the proton conductive material 27, and a coating state of the supported catalysts. In the catalyst layer 20, the aqueous methanol solution fuel diffuse to the catalyst fine particles 22 and 25 by way of the pores 28 and the proton conductive material 27, and reacts there. Part of the fuel passes through the electrolyte membrane, and diffuses to the cathode. Electrons move to the current collector by way of the catalyst fine particles 22 and 25 and the supports 21 and 24, and the reaction product CO₂ is diffused to the current collector through the pores 28 and the proton conductive material 27. In order to improve the liquid fuel diffusion and suppress crossover at the same time, proper porosity, pore size and pore distribution are required. If the porosity is too high, or there are many large pores, the crossover is large. To the contrary, if the porosity is too low, or there are many small pores, supply of the fuel is poor, triple phase boundaries of fuel-catalyst-electrolyte of the catalyst layer is poor, and the cell output is low. In this invention, to obtain high cell output, the catalyst layer is preferred such that the porosity is 20 to 65%, the volume of pores of which diameter ranges from 50 to 800 nm is 30% or more of the total pore volume of the catalyst layer, and the pore diameter distribution in which a distribution peak of the pore diameter is in a range of 100 to 800 nm is provided. More preferably, the catalyst layer is preferred such the porosity is 30 to 55%, the volume of pores of which diameter ranges from 50 to 800 nm is 50% or more and less than 100% of the total pore volume of the catalyst layer, and the pore diameter distribution in which a distribution peak of the pore diameter is in a range of 100 to 600 nm is provided. Such proper pore distribution seems to have good effects on affinity of the catalyst layer and fuel.

To realize the pore distribution, it is required to optimize the shape, size, and content ratio of the fibrous supported catalysts and granular supported catalysts, and further the content ratio of the proton conductive substance. As for the size, if the fibrous supported catalysts are too thick, the space between skeletons is very large, and it is hard to supply the fuel into the catalyst portion inside the space formed by the granular supported catalysts. If the fibrous supported catalysts are too thin, the space between skeletons is small and it is hard to fill in the granules. If the granular supported catalysts are too large, the filling effect is poor. If the granular supported catalysts are too small, it is hard to supply the fuel into the catalyst portion inside the space formed by the granular supported catalysts, aggregation is likely to occur, and the filling effect is poor. To form an appropriate porous structure, it is preferred to combine at least two types of catalysts, that is, fibrous supported catalysts having an average diameter of 80 to 500 nm, and granular supported catalysts whose average primary particle diameter is not larger than half of the average diameter of the fibrous supported catalysts. A particularly preferred combination is fibrous supported catalysts having an average diameter of 100 to 300 nm, and granular supported catalysts having an average primary particle diameter of 20 to 80 nm. As for the content ratio of the supported catalysts, if the content ratio of the fibrous supported catalysts are small, few skeletons are formed by the fibrous supported catalysts, the amount of the granular catalyst filled is large, the pore size is small, the porosity is low, and it is hard to supply the fuel properly. Further, electroconductive pass and proton conductive pass are not sufficient, which leads to lowering of the cell output. To the contrary, when the content ratio of the granular supported catalysts are low, the space in the skeletons is less filled by the granular supported catalysts, the porosity is high, and there are many large pores. Therefore, crossover of methanol to the cathode is significant, and hence the cell performance is considered to be lowered. To realize an optimum porous structure, it is preferred to contain the fibrous supported catalysts and granular supported catalysts by 15 wt. % to 70 wt. %, respectively. The content ratio of the supported catalysts is determined from the ratio of the content of the supported catalysts to the total weight of the catalyst layer. The content of the supported catalysts means a total of support weight and catalyst weight thereon.

As for the content ratio of the proton conductive material, if the blending amount of the proton conductive material is too low, sufficient proton conductive pass is not formed. If the blending amount of the proton conductive material is too high, catalyst particles are covered with the proton conductive substance, and catalytic reaction or electron pass is blocked by the proton layer. Anyway, it results in lowering of the cell output. In the catalyst layer of the invention, the content ratio of the proton conductive material is preferred to be 15 to 40 wt. %. Examples of the proton conductive material include fluorine resin having a sulfonic acid group such as, for example, NAFION (registered trademark), but not limited thereto. Any proton conductive material may be used, but it may be necessary to adjust the process in consideration of affinity for the catalyst layer.

In the invention, further, in order to improve the diffusion and suppress crossover at the same time, it is preferred to have a pore diameter decreasing structure in which the pore size becomes smaller from the catalyst layer surface facing the current collector to the catalyst layer surface positioned at the opposite side of this surface along the thickness direction. In this structure, since the pore size is larger in the catalyst layer closer to the current collector, the fuel is supplied smoothly. As becoming closer to the proton electrolyte membrane, the pore size is smaller, so that fuel diffusion becomes gradually slow in the thickness direction of the catalyst layer, and it seems effective to suppress fuel penetration into the cathode. As a result, effects of improving diffusion and suppressing crossover are both enhanced, which contributes to higher output of the DMFC. If the average decreasing rate of the pore size relative to the thickness 1 μm of the catalyst layer is too small, it is possible that the effect of enhancing crossover suppression may be weaker. On the other hand, if the average decreasing rate is too high, fuel supply in the catalyst layer closer to the electrolyte membrane is poor, and the triple phase boundaries of fuel-catalyst-electrolyte in the catalyst layer is slightly lowered. Hence, the average decreasing rate of the pore size relative to the thickness 1 μm of the catalyst layer is preferred to be 5 to 20 nm. Jpn. Pat. Appln. KOKAI Publication No. 2003-200052 discloses a catalyst layer structure having two layers different in density, that is, a coarse catalyst layer made of fibrous supported catalysts and a dense catalyst layer made of granular supported catalysts. However, this structure is different from the pore diameter decreasing structure of the invention, and the pore size is suddenly decreased at the interface of two layers. In the catalyst layer structure, the triple phase boundaries of gas-catalyst-electrolyte is low in the portion of the coarse catalyst layer, diffusion of the fuel and CO₂ is insufficient in the portion of the dense catalyst layer, and electroconductive pass and proton conducive pass are insufficient between two layers. It seems difficult to satisfy both improvement of diffusion and suppression of crossover as realized in the pore diameter decreasing structure of the invention.

In the invention, mixing of two types of catalysts, the fibrous supported catalysts and the granular supported catalysts are explained, but not limited thereto. Aside from two types of catalysts, the cell performance may be further enhanced by mixing other catalysts such as supported catalysts carried on conductive supports such as nanohorns or nanotubes, or supports-free catalysts.

The supported catalysts will be further explained below.

The above-described specific pore distribution is necessary in the anode catalyst layer of the invention, but it is not enough to obtain sufficient performance. Although the cause is not clarified yet, the affinity of the liquid fuel and the supported catalysts seems to be very important aside from the porous structure (pore distribution, pore size, pore network). The affinity of the liquid fuel and the supported catalysts is a factor having effects on fuel supply, CO₂ discharge, and progress of electrode reaction, aside from the porous structure. Complicated factors are related to the electrode reaction on the surface of catalyst nano-particles in the anode catalyst layer in the power generation, and the mechanism is not clarified yet. Influential factors are considered to include the shape of supported catalysts, the shape of supports, surface state, surface structure, the composition of supported catalysts, properties of supported catalysts, density of supported catalysts, the state of proton conductive material covered on supported catalyst surface, and interaction of two types of supported catalysts. As a result of intensive studies for the invention, it has been found that selection of the fibrous supported catalysts and granular supported catalysts is indispensable, together with optimization of pore distribution in order to realize an optimum catalyst layer of the direct methanol fuel cells (DMFC).

As for the fibrous supported catalysts, the carbon nanofiber material is limited to the supports of the fibrous supported catalysts in the invention in consideration of the conductivity and material cost, but other fiber material than carbon may be also used. Various types of carbon nanofibers have been reported depending on the manufacturing method, structure, and surface state. From the viewpoint of the structure, they may be classified into a structure in which graphite closest-packing planes are parallel to a fiber length direction (a so-called ribbon structure), and a structure in which graphite closest-packing planes are oriented at an angle of 30 degrees or more and 90 degrees or less relative to the fiber length direction (a so-called herringbone structure or platelet structure). In the invention, the preferred catalyst layer includes fibrous supported catalysts having catalyst fine particles carried on carbon nanofibers having the herringbone or platelet structure. A particularly preferred carbon nanofiber supports should have the herringbone or platelet structure having a specific surface area of 100 m²/g or more and a pore volume of 0.15 cc/g or more. Since the surface state of the nanofiber strongly depends on the specific surface area and pore volume, the high specific surface area and high pore volume seem to contribute to enhancement of affinity of the liquid fuel and the catalyst layer, aside from high density carrying of catalyst fine particles. The upper limit of the specific surface area is preferred to be 500 m²/g. The upper limit of the pore volume is preferred to be 0.6 cc/g. If exceeding the upper limit, stable high output may not be obtained. Although the reason is not clear, it is considered that, if too high, the specific surface area and pore volume may have effects on the surface state of nanofibers, or the distribution state of catalyst fine particles, and the affinity of the liquid fuel and the catalyst layer are slightly lowered. Much has been studied about carbon nanofibers having another structure, but it is hard to obtain stable high output. Although the reason is not known, it is deemed that the edge opening among the graphite sheets on the surface of the fiber having the herringbone or platelet structure seem to play important roles of improving affinity and the like. The carbon nanofibers having another structure by surface treatment also seem to be an application of the invention.

As for the granular supported catalysts, the granular supports are preferred to be carbon black particles excellent in conductivity and durability. As explained above, carbon black of which average diameter is not larger than half of the average diameter of the fibrous supported catalysts is preferred for the adequate porous structure. More preferably, the average diameter of carbon black is 20 to 80 nm. The catalyst layer includes preferably carbon black having a specific surface area of 20 to 800 m²/g and a dibuthyl phthalate absorption value of 15 to 500 ml/100 g, and more preferably, carbon black having a specific surface area of 40 to 300 m²/g and a dibuthyl phthalate absorption value of 20 to 300 ml/100 g. More excellent performance is obtained by using such carbon black as the granular supports. Although the reason is not clear, it seems to be owing to further improvements of the surface structure and surface state of carbon black, and affinity of fuel, CO₂ and proton conductive material by a chain structure (aggregate structure) of primary particles called structure represented by a dibuthyl phthalate absorption value.

In the invention, sphere-like granular supports such as carbon black are explained, but not limited thereto. The granular supports with other shapes can also be used.

The material of the catalyst fine particles carried on the supports is a platinum alloy catalyst. Examples of the platinum alloy catalyst includes an alloy or a compound containing platinum, such as PtRu alloy, PtRuSn alloy, PtFe alloy, or PtFeN, but not limited thereto. However, much oxygen is detected in or near the catalyst fine particles of the invention, and thus, when another catalyst material having high catalyst activity or high durability is used, presence of oxygen in or near said another catalyst material is preferred to obtain an affinity with the fuel, CO₂ and proton conductive material. In order to obtain a high cell output, it is preferred to use a supported catalysts having uniform and dense catalyst fine particles and high support density, for example, a supported catalysts having catalyst fine particles of 2 to 5 nm in diameter, and support density of 20 wt. % or more. The invention can realize the highest output at supports density of 35 to 70 wt. % (at a constant catalyst loading amount per unit area of the electrode). Also the catalyst fine particles on the support surface have effects on the surface state of the supports, and the high support density seems to enhance the affinity of the liquid fuel and the catalyst layer. If the support density is too high, granular growth of catalyst fine particles is likely to occur, the specific surface area of the catalyst is lowered, the effective reaction site of catalyst reaction decreases, and the cell performance is lowered. Besides, the proton conductive substance is less likely to be coated on the catalyst existing in superfine pores of the support surface, and therefore, the efficiency of use of the catalyst is lowered. The method of manufacturing supported catalysts includes a solid phase reaction method, a solid phase-vapor phase reaction method, a liquid phase method, and a vapor phase method. The liquid phase method includes an impregnation method, a sedimentation method, a coprecipitation method, a colloid method, and an ion exchange method.

The specific surface area and pore volume of the supports can be measured by a BET method. The structure of the supports, the average aspect ratio, the average diameter, and the diameter of catalyst particles can be determined by a transmission electron microscope (TEM), or a high power FE-SEM electron microscope. The support density can be measured by chemical composition analysis. The dibuthyl phthalate absorption value can be measured by a mercury porosimetry method. The content of the supported catalysts in the catalyst layer and the content of the proton conductive material in the catalyst layer can be determined from the weight composition and electrode weight changes in process. The content ratio of the supported catalysts (total) and the proton conductive material can be confirmed also by chemical analysis. The pore distribution of the catalyst layer is calculated by measuring the pore distribution of the anode including the catalyst layer and diffusion layer in accordance with a mercury porosimetry method, and subtracting the pore distribution of the diffusion layer from the pore distribution of the anode. The pore diameter decreasing structure can be observed by transmission electron microscope (TEM) analysis. Supposing the thickness of the proton conductive substance coated on the supported catalyst surface is constant, the average decreasing rate of the pore size to the catalyst layer thickness can be determined. When determining the structure of the supports, the average aspect ratio, the average diameter, and the diameter of catalyst particles from the transmission electron microscope (TEM) or high power FE-SEM electron microscope, the measuring viewing field is assumed to be 10. It is the same when determining the pore diameter decreasing structure and the average decreasing rate of the pore size by the transmission electron microscope (TEM).

A method of manufacturing electrodes and MEA of the invention will be explained below.

Electrodes can be manufactured in wet process and dry process, and a slurry method and a deposit impregnation method of wet process will be described below. The invention can be also applied in another method of manufacturing electrodes, such as a transfer method.

<Slurry Method>

After water is added to supported catalysts and agitated sufficiently, a proton conductive solution is added, and an organic solvent is added, the mixture is stirred well to prepare slurry. The organic solvent to be used is single solvent or a mixed solvent of two or more types. For dispersing, a general dispersing machine is used (for example, a ball mill, a sound mill, a beads mill, a paint shaker, or a nanomizer), and a slurry composition can be prepared as a dispersion solution. The prepared dispersion solution (slurry composition) is applied on a current collector (carbon paper or carbon cloth) by various methods, and dried to obtain an electrode having the above electrode composition.

<Deposit Impregnation Method>

Fibrous supported catalysts and granular supported catalysts are weighed by a predetermined composition ratio, water is added, the mixture is stirred sufficiently and dispersed, and the supported catalysts are deposited on a current collector (carbon paper or carbon cloth) to form a catalyst layer. After drying, the catalyst layer is impregnated in a solution having a proton conductive material dissolved therein, and dried to obtain an electrode having the above electrode composition. For depositing the catalyst, either suction filtration method under reduced pressure or spray method may be applied, and a suction filtration method under reduced pressure is mainly studied in the invention.

Further, in the invention, by making use of a sedimentation speed difference when applying and drying the catalyst layer due to a weight difference between the fibrous supported catalysts and the granular supported catalysts, the content ratio of the granular catalyst and the fibrous supported catalysts (R=content of granular supported catalysts/content of fibrous supported catalysts) is varied in the catalyst layer thickness direction, and R is raised from the current collector of the electrode toward the electrolyte membrane, thereby realizing a pore diameter decreasing structure. In the case of the slurry method, a sedimentation speed difference between two supported catalysts in the slurry is realized by adjusting the slurry viscosity and drying speed. The solvent amount in the slurry composition at this time is adjusted such that the solid content is 2 to 20 wt. % and the drying speed is 3 to 20 hours. In the case of the deposit impregnation method, by adjusting the concentration and temperature of a mixed solution of the fibrous supported catalysts, granular supported catalysts and water, a sedimentation speed difference of two supported catalysts during suction and filtration is utilized. The solvent amount in the mixed solution at this time is adjusted such that the solid content is 5 wt. % or less.

For supply of the fuel or discharge of CO₂, the current collector (carbon paper or carbon cloth) may be used after water repellent or hydrophilic treatment and drying.

An anode is manufactured in either one of the two methods, a proton conductive membrane is arranged between the obtained anode and cathode, and thermally compressed by roll or press, and a membrane electrode assembly is obtained. Condition of thermal compression for obtaining the membrane electrode assembly is preferably that the temperature is 100° C. or more and 180° C. or less, the pressure is in a range of 10 to 200 kg/cm², and the compression time is in a range of 1 minute or more and 30 minutes or less.

The cathode catalyst contained in the cathode is, for example, Pt or platinum alloy, but not limited thereto. As the cathode catalyst, either supported catalysts or support-free catalyst may be used.

The proton conductive material contained in the proton conductive membrane is, for example, fluorine resin having a sulfonic acid group such as NAFION (registered trademark), but not limited thereto.

Embodiments of the invention are described below, but it must be noted that the invention is not limited to Examples alone.

### EXAMPLE 1

(Anode)

An anode was fabricated by a suction filtration method. Fibrous supported catalysts was 40 wt. % of PtRu_{1.5} fine particles supported on herringbone nanocarbon fibers having an average diameter of 250 nm, a specific surface area of 300 m²/g, a pore volume of 0.3 cc/g, and an average aspect ratio of 50, and granular supported catalysts was 40% of PtRu_{1.5} carried on carbon black having an average primary particle diameter of 50 nm, a specific surface area of 50 m²/g, and a dibuthyl phthalate absorption value of 50 ml/100 g. 30 mg of the fibrous supported catalysts and 45 mg of the granular supported catalysts are weighed, 150 of purified water was added, the mixture is stirred well, and then dispersed and heated to obtained a mixed solution having a solid content of 0.05 wt. % and temperature of 85° C. By applying suction filtration under reduced pressure to the obtained mixed solution with a porous carbon paper of 10 cm² (350 μm, Toray) subjected to water repellent treatment, the supported catalysts was deposited on the carbon paper, and dried. A solution having 4% of NAFION (of Dupont) as a proton conductive material dissolved therein was impregnated in reduced pressure and dried. As a result, weight increase of 35 mg was confirmed in the catalyst layer, and it seemed that the proton conductive material was added by 35 mg. Thus, an anode with noble metal loading density of about 3 mg/cm² was fabricated.

(Cathode)

A cathode was prepared by a slurry method. Precisely, 2 of purified water was stirred well with 1 g of granular supported catalysts having 50 wt. % of Pt fine particles carried on granular carbon with a specific surface area of about 40 m²/g or more, an average diameter of 50 nm, and an aspect ratio of about 1. Further, after adding 4.5 g of a 20% NAFION solution and 10 g of 2-ethoxy ethanol and stirring well, the mixture was dispersed by a desktop ball mill to prepare a slurry composition. The slurry composition was applied on a water repellent carbon paper (350 μm, manufactured by Toray Industries, Inc.) by a control coater and dried in air, and a cathode with a catalyst loading density of 2 g/cm² was fabricated. Cathodes in other examples and comparative examples were manufactured similarly, but the cathode of the invention is not limited to them alone.

<Preparation of Membrane Electrode Assembly (MEA)>

A cathode and an anode were cut in square of 3.2×3.2 cm so as to obtain an electrode area of 10 cm² each, NAFION 117 was placed between the cathode and the anode as a proton conductive solid polymer membrane, and thermally compressed at pressure of 100 kg/cm² for 30 minutes at 125° C., and a membrane electrode assembly (MEA) having the structure as shown in FIG. 1 was fabricated. Membrane electrode assemblies in other examples and comparative examples were manufactured similarly, but the membrane electrode assembly of the invention is not limited to them alone.

Using this membrane electrode assembly (MEA) and a passage plate, a single cell of a direct methanol fuel cell (DMFC) was fabricated. In the single cell, a 1M aqueous methanol solution was supplied as a fuel to the anode at a flow rate of 0.6 ml/min., air was supplied to the cathode at 100 ml/min., and while the cell was maintained at 70° C., a cell voltage and a crossover rate at current density of 150 mA/cm² were measured. Results are shown in Table 1. In this measuring condition, by discharging for 3 hours at current density of 150 mA/cm², the mass balance at this time was measured, and the crossover rate (CO. rate) was determined in the following formula (1):
CO. rate=X/Y (1)
where X is the amount of methanol passing to the cathode, which was determined by subtracting the methanol theoretical consumption of the anode from the amount of methanol supplied to the anode; and Y is the amount of methanol supplied to the anode.

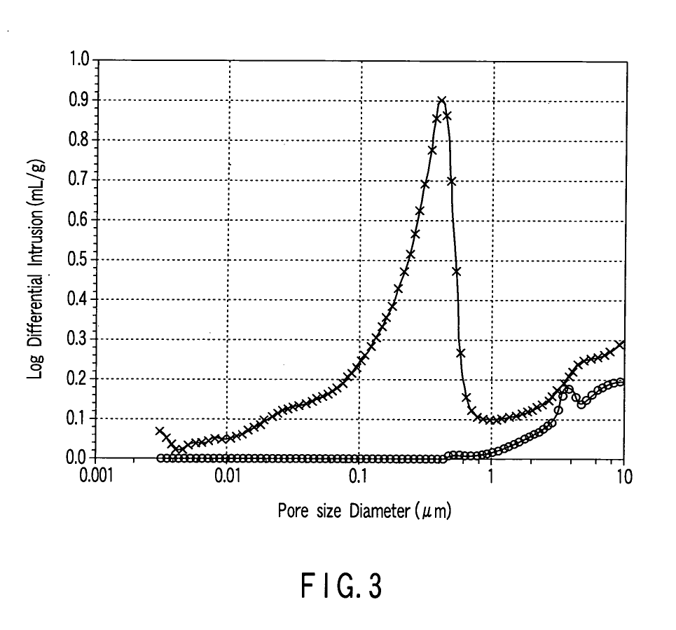

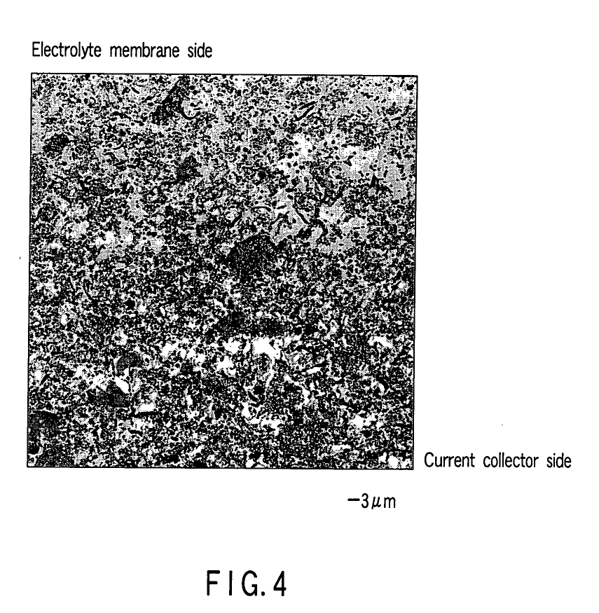

To evaluate the porous structure of the anode, an anode catalyst layer was formed on a carbon paper in the same manner as explained above (anode), and only the anode was thermally compressed at pressure of 100 kg/cm² for 30 minutes at 125° C. in the same condition as in the MEA fabrication process, and a pore size distribution was measured by a mercury porosimetry method (Shimadzu Auto Pore model 9520). A distribution of the carbon paper was subtracted from the pore size distribution of the anode, and the pore size distribution of the catalyst layer was determined. From the results of measurement, the porosity, fine pore percentage (percentage of volume of fine pores distributing in a diameter range of 50 to 800 nm in entire pore volume), and a pore diameter of distribution peak were determined, and results are shown in Table 1. FIG. 3 shows the pore diameter distributions of the anode catalyst layer and its carbon paper. The axis of abscissas in FIG. 3 represents the pore size diameter (μm), and the axis of ordinates represents a log differential instruction (mL/g), that is, a pore volume per unit weight. The curve indicated by circle mark in FIG. 3 is the pore size distribution of the carbon paper, and the curve indicated by x-mark is that of the anode. As known from the results in FIG. 3, the porosity of the anode catalyst layer is 40%, the volume of pores distributing in a diameter range of 50 to 800 nm is 60% of the entire volume, and the distribution peak of the pore diameter is in a range of 100 to 800 nm. The catalyst layer was measured by transmission electron microscope (TEM) analysis. FIG. 4 shows a TEM photograph. Granules of a diameter of 100 nm or more are sections of the fibrous catalyst. Pores in the catalyst layer closer to the current collector are large, and pores in the catalyst layer closer to the electrolyte membrane are smaller. The average decreasing rate of the pore size per 1 um of thickness of the catalyst layer was 10 nm.

### EXAMPLE 2

An anode was manufactured in the same manner as in Example 1, except that the average diameter of carbon nanofibers was 200 nm, the specific surface area was 150 m²/g, the average aspect ratio was 30, the average primary particle diameter of carbon black was 50 nm, the specific surface area was 150 m²/g, the dibuthyl phthalate absorption value was 100 ml/100 g, the fibrous supported catalysts content and granular supported catalysts content were 45 mg and 30 mg, respectively, the solid content of the mixture of the fibrous supported catalysts, granular supported catalysts and water was 0.2 wt. %, the temperature was 25° C., and the content of the proton conductive material NAFION (Dupont) was 25 mg. From the obtained anode, the DMFC was fabricated in the same manner as in Example 1, and the anode was evaluated. Results are shown in Table 1.

### EXAMPLE 3

An anode was manufactured in the same manner as in Example 1, except that average diameter of carbon nanofibers was 150 nm, the specific surface area was 400 m²/g, the average aspect ratio was 80, the average primary particle diameter of carbon black was 30 nm, the specific surface area was 250 m²/g, the dibuthyl phthalate absorption value was 175 ml/100 g, the fibrous supported catalysts content and granular supported catalysts content were 60 mg and 25 mg, respectively, the solid content of the mixture of the fibrous supported catalysts, granular supported catalysts and water was 1 wt. %, the temperature was 90° C., and the content of the proton conductive material NAFION (Dupont) was 20 mg. From the obtained anode, the DMFC was fabricated in the same manner as in Example 1, and the anode was evaluated. Results are shown in Table 1.

### EXAMPLE 4

An anode was manufactured in the same manner as in Example 1, except that the method was changed to a slurry method. First, 0.9 g of the fibrous supported catalysts and 1.35 g of the granular supported catalysts were stirred well with 2 g of purified water. Further, after adding 3.75 g of a 20% NAFION solution and 20 g of 2-ethoxy ethanol and stirring well, the mixture was dispersed by a desktop ball mill, and a slurry composition with a solid content of about 10.7 wt. % was prepared. The slurry composition was applied on a water repellent carbon paper (350 μm, manufacture by Toray Industries, Inc.) by a control coater and dried for 8 hours at humidity of 80%, and an anode with a noble metal catalyst loading density of 3 mg/cm² was fabricated.

Same as in Example 1, MEA and DMFC single cell were fabricated, and the single cell performance, electrode, and electrode structure were evaluated. Results are summarized in Table 1. The structure similar to those in Example 1 and high cell performance were obtained.

### EXAMPLE 5

An anode was manufactured in the same manner as in Example 4. First, 0.6 g of fibrous supported catalysts and 1.65 g of granular supported catalysts were stirred well with 2 g of purified water. Further, after adding 5 g of a 20% NAFION solution and 15 g of 2-ethoxy ethanol and stirring well, the mixture was dispersed by a desktop ball mill, and a slurry composition with a solid content of about 13.4% was prepared. The slurry composition was applied on a water repellent carbon paper (350 μm, manufactured by Toray Industries, Inc.) by a control coater and dried for 12 hours at humidity of 80%, and an anode with a noble metal catalyst loading density of 3 mg/cm² was fabricated.

Same as in Example 1, MEA and DMFC single cell were fabricated, and the single cell performance, electrode, and electrode structure were evaluated. Results are summarized in Table 1. The structure similar to those in Example 1 and high cell performance were obtained.

### EXAMPLE 6

An anode was manufactured in the same manner as in Example 4. First, 1.5 g of fibrous supported catalysts and 0.75 g of granular supported catalysts were stirred well with 2 g of purified water. Further, after adding 2.5 g of a 20% NAFION solution and 12 g of 2-ethoxy ethanol and stirring well, the mixture was dispersed by a desktop ball mill, and a slurry composition with a solid content of about 14.7% was prepared. The slurry composition was applied on a water repellent carbon paper (350 μm, manufactured by Toray Industries, Inc.) by a control coater and dried for 16 hours at humidity of 90%, and an anode with a noble metal catalyst loading density of 3 mg/cm² was fabricated.

Same as in Example 1, MEA and DMFC single cell were fabricated, and the single cell performance, electrode, and electrode structure were evaluated. Results are summarized in Table 1. The structure similar to those in Example 1 and high cell performance were obtained.

### COMPARATIVE EXAMPLES 1 and 2

In Comparative example 1, using the same fibrous supported catalysts as in Example 1, an anode was fabricated by using only the fibrous supported catalysts, and in Comparative example 2, using the same granular supported catalysts as in Example 4, an anode was fabricated by using only the granular supported catalysts. The noble metal loading density was 3 mg/cm² same as in Examples 1 and 2. Same as in Example 1, MEA and DMFC single cell were fabricated, and the single cell performance, electrode, and electrode structure were evaluated. Results are summarized in Table 1. Both were lower in cell output as compared with Examples 1 and 2. Comparative example 1 was larger in crossover, and Comparative example 2 had more cracks of several microns in width in the catalyst layer. In the measuring results of the pore size distribution, Comparative example 1 was higher in porosity, showing a distribution peak of the pore diameter in a range of 800 to 1000 nm, and Comparative example 2 was lower in porosity, not having a distribution peak of the pore diameter in a range of 1000 nm or less. An optimum pore size distribution was not obtained, which seems to be cause of lower output in Comparative examples 1 and 2.

### COMPARATIVE EXAMPLES 3 and 4

In comparative examples 3 and 4, anodes were fabricated in the same manner as in Example 1, except that the fibrous supported catalysts was changed. Comparative example 3 used fibrous supported catalysts with supports density of 40 wt. % using a fiber supports having a herringbone structure of 50 nm in average diameter and 100 m²/g in specific surface area, and Comparative example 4 used fibrous supported catalysts with supports density of 40 wt. % using a fiber supports having a herringbone structure of 1000 nm in average diameter and 50 m²/g in specific surface area. Anodes were fabricated same as in Example 1 (noble metal loading density of about 3 mg/cm²), MEA and DMFC single cell were similarly fabricated, and the single cell performance, electrode, and electrode structure were evaluated. Results are summarized in Table 1. Both were lower in cell output as compared with Examples 1 and 2. In the pore size distribution results, both were lower in the rate of fine pores, the diameter of the fibrous supported catalysts was not proper, and an optimum pore size distribution was not obtained, which seems to be cause of lower cell output.

### COMPARATIVE EXAMPLES 5 and 6

In comparative examples 5 and 6, anodes were fabricated in the same manner as in Example 1, except that the fibrous supported catalysts was changed. By using fibrous supported catalysts with supports density of 40 wt. % using a multilayer carbon nanotube (MWCNT) supports of 80 nm in average diameter and 20 m²/g in specific surface area in Comparative example 5, and fibrous supported catalysts with supports density of 40 wt. % using a vapor phase growth graphite fiber (VCGF) supports of 300 nm in average diameter and 50 m²/g in specific surface area in Comparative example 6, anodes were fabricated same as in Example 1 (noble metal loading density of about 3 mg/cm²), MEA and DMFC single cell were similarly fabricated, and the single cell performance, electrode, and electrode structure were evaluated. Results are summarized in Table 1. Both were lower in cell output as compared with Examples 1 and 2 as shown in Table 1. In the pore size distribution results, there was no significant difference from Examples 1 and 2, and the cause of lower performance seems to lie in poor affinity of the catalyst layer and fuel due to the surface state of the fibrous supported catalysts, failing to obtain an optimum catalyst layer.

### COMPARATIVE EXAMPLE 7 and EXAMPLES 7 and 8

In comparative example 7 and Examples 7 and 8, anodes were fabricated in the same manner as in Example 2, except that the granular supported catalysts was changed. By using granular supported catalysts with supports density of 20 wt. % using a carbon powder supports of 300 nm in average diameter in Comparative example 7; granular supported catalysts with support density of 40 wt. % using a carbon black supports of 40 nm in average diameter, 800 m²/g in specific surface area, and 500 ml/100 g in a dibuthyl phthalate absorption value in Example 7; and granular supported catalysts with supports density of 15 wt. % using the same granular supports as in Example 2 in Example 8, anodes were fabricated same as in Example 2 (noble metal loading density of about 3 mg/cm²), MEA and DMFC single cell were similarly fabricated, and the single cell performance, electrode, and electrode structure were evaluated. Results are summarized in Table 1. In Comparative example 7, the porosity was high, the fine pore rate was low, the diameter of the granular supported catalysts was not proper, and an optimum pore size distribution was not obtained, which seems to be cause of low cell output. In Examples 7 and 8, the pore size distribution was not significantly different from those of Examples 1 and 2, and the cause of insufficient performance seems to be slightly poor affinity of the catalyst layer and fuel due to the surface state of the granular supported catalysts, failing to obtain an optimum catalyst layer.

### EXAMPLES 9 and 10

In Examples 9 and 10, anodes were fabricated in the same manner as in Example 1, except that the impregnation amount of the proton conductive substance NAFION was changed. The impregnation amount of NAFION was 10 mg and 60 mg, respectively, in Examples 9 and 10, anodes were fabricated same as in Example 1 (noble metal loading density of about 3 mg/cm²), MEA and DMFC single cell were similarly fabricated, and the single cell performance, electrode, and electrode structure were evaluated. Results are summarized in Table 1. As known from the results, it is understood that a higher output will be obtained by controlling the content ratio of NAFION in the catalyst layer in a proper range.

### EXAMPLE 11

An electrode, MEA, and direct methanol fuel cell (DMFC) were fabricated same as in Example 4, except that the amount of 2-ethoxy ethanol of the slurry was changed from 20 g to 6 g, with the solid content changed to 25 wt. % and the drying speed to 1 hour, and the single cell performance, electrode, and electrode structure were evaluated. Results are summarized in Table 1. As known from Table 1, as compared with Example 4, the cell output was slightly lower. Results of measurement of the pore structure by the mercury porosimetry method were not significantly different from Example 4, but presence of the pore diameter decreasing structure was hardly noted in TEM observation. It is thus known that formation of the pore diameter decreasing structure is effective for suppression of crossover and further enhancement of cell output.

TABLE 1

| | Content | Content | | | | | | | |
|---|---|---|---|---|---|---|---|---|---|
| | ratio of | ratio of | Content | | | Pore | Average | | |
| | fibrous | granular | ratio | | | distribution | decreasing | | |
| | supported | supported | of | | Fine pores | peak | rate of | | Crossover |
| | catalysts | catalysts | NAFION | Porosity | percentage* | diameter | pore size | Voltage | rate |
| | (wt. %) | (wt. %) | (wt. %) | (%) | (%) | (nm) | (nm/μm) | (150 mA/cm²) | (%) |
| Example 1 | 27.3 | 40.9 | 31.8 | 40 | 60 | 400 | 10 | 0.50 | 15 |
| Example 2 | 45.0 | 30.0 | 25.0 | 50 | 55 | 450 | 12 | 0.50 | 16 |
| Example 3 | 57.1 | 23.8 | 19.1 | 55 | 55 | 450 | 8 | 0.50 | 16 |
| Example 4 | 30.0 | 45.0 | 25.0 | 35 | 60 | 400 | 10 | 0.50 | 16 |
| Example 5 | 18.5 | 50.8 | 30.8 | 30 | 50 | 400 | 8 | 0.49 | 16 |
| Example 6 | 54.5 | 27.3 | 18.2 | 40 | 55 | 500 | 15 | 0.49 | 16 |
| Comparative | 68.2 | 0 | 31.8 | 70 | 30 | 950 | 0 | 0.44 | 23 |
| example 1 | | | | | | | | | |
| Comparative | 0 | 75.0 | 25.0 | 15 | 15 | >1000 | 0 | 0.41 | 21 |
| example 2 | | | | | | | | | |
| Comparative | 27.3 | 40.9 | 31.8 | 30 | 25 | 350 | 5 | 0.42 | 20 |
| example 3 | | | | | | | | | |
| Comparative | 27.3 | 40.9 | 31.8 | 50 | 20 | 800 | 16 | 0.42 | 20 |
| example 4 | | | | | | | | | |
| Comparative | 27.3 | 40.9 | 31.8 | 35 | 50 | 400 | 7 | 0.43 | 15 |
| example 5 | | | | | | | | | |
| Comparative | 27.3 | 40.9 | 31.8 | 45 | 55 | 550 | 12 | 0.41 | 16 |
| example 6 | | | | | | | | | |
| Comparative | 34.6 | 46.2 | 19.2 | 70 | 25 | 800 | 13 | 0.42 | 19 |
| example 7 | | | | | | | | | |
| Example 7 | 27.3 | 40.9 | 31.8 | 45 | 50 | 300 | 10 | 0.47 | 16 |
| Example 8 | 30.0 | 53.3 | 16.7 | 35 | 45 | 300 | 10 | 0.47 | 15 |
| Example 9 | 35.3 | 52.9 | 11.8 | 28 | 60 | 300 | 2 | 0.47 | 17 |
| Example 10 | 22.2 | 33.3 | 44.5 | 37 | 60 | 450 | 8 | 0.46 | 16 |
| Example 11 | 30.0 | 45.0 | 25.0 | 28 | 55 | 350 | 0 | 0.48 | 16 |

*percentage of volume pores of which diameter is in a range of 50 to 800 nm in a total pore volume.

In Examples, the fibrous supported catalysts having the herringbone structure are explained, but same effects were obtained in the platelet structure.

Hence, the invention has been clarified to improve the catalyst layer, and enhance the output of the fuel cell. As explained herein, the invention can optimize the pore size distribution by mixing the carbon nanofiber supported catalysts and granular supported catalysts, and by finding out fibrous supported catalysts and granular supported catalysts having high affinity for a liquid fuel, can provide a fuel cell having an optimum catalyst layer structure, an excellent electrode and high output capable of improving the diffusion and suppressing the fuel crossover at the same time.

The invention hence presents an anode for liquid fuel cell capable of satisfying both diffusion of a liquid fuel and crossover suppression of the liquid fuel, a membrane electrode assembly for liquid fuel cell including the anode, and a liquid fuel cell including the anode.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An anode for liquid fuel cell, comprising a current collector, and a catalyst layer provided on the current collector,
wherein the catalyst layer has a porosity in a range of 20 to 65%, a volume of pores of which diameter ranges from 50 to 800 nm is 30% or more of a pore volume of the catalyst layer,
the catalyst layer has a pore diameter distribution having a peak in a range of 100 to 800 nm, and
the catalyst layer comprises fibrous supported catalysts and granular supported catalysts, the fibrous supported catalysts contain carbon nanofibers having a herringbone or platelet structure, and catalyst particles carried on the carbon nanofibers, and the granular supported catalysts contain carbon black particles and catalyst particles carried on the carbon black particles.

2. The anode for liquid fuel cell according to claim 1, wherein the catalyst layer has a first surface facing the current collector, and a second surface on the side opposite to the first surface, a pore diameter of the second surface is smaller than a pore diameter of the first surface, and an average decreasing rate of the pore diameter per 1 μm of thickness of the catalyst layer is 5 to 20 nm.

3. The anode for liquid fuel cell according to claim 1, wherein the volume of pores of which diameter ranges from 50 to 800 nm is 50% or more of the pore volume of the catalyst layer.

4. The anode for liquid fuel cell according to claim 1, wherein the catalyst layer contains a proton conductive material, and the content of the proton conductive material in the catalyst layer is 15 to 40 wt. %.

5. The anode for liquid fuel cell according to claim 4, wherein the proton conductive material comprises fluorine resin having a sulfonic acid group.

6. The anode for liquid fuel cell according to claim 1, wherein the porosity is 30 to 55%.

7. The anode for liquid fuel cell according to claim 1, wherein the peak of the pore diameter distribution is in a range of 100 to 600 nm.

8. The anode for liquid fuel cell according to claim 1, wherein an average diameter of the fibrous supported catalysts are in a range of 80 to 500 nm, and an average primary particle diameter of the granular supported catalysts are not more than half of the average diameter of the fibrous supported catalysts.

9. The anode for liquid fuel cell according to claim 1, wherein an average diameter of the fibrous supported catalysts are in a range of 100 to 300 nm, and an average primary particle diameter of the granular supported catalysts are in a range of 20 to 80 nm.

10. The anode for liquid fuel cell according to claim 1, wherein a specific surface area of the carbon nanofibers is in a range of 100 to 500 m²/g, and a pore volume of the carbon nanofibers is in a range of 0.15 to 0.6 cc/g.

11. The anode for liquid fuel cell according to claim 1, wherein a specific surface area of the carbon black particles is in a range of 20 to 800 m²/g, and a dibuthyl phthalate absorption value of the carbon black particles is in a range of 15 to 500 ml/100 g.

12. The anode for liquid fuel cell according to claim 1, wherein a specific surface area of the carbon black particles is in a range of 40 to 300 m²/g, and a dibuthyl phthalate absorption value of the carbon black particles is in a range of 20 to 300 ml/100 g.

13. The anode for liquid fuel cell according to claim 1, wherein an average aspect ratio of the carbon nanofibers is 10 or more, and an average aspect ratio of the carbon black particles is 4 or less.

14. A membrane electrode assembly for liquid fuel cell, comprising an anode, a cathode, and a proton conductive layer provided between the anode and the cathode,
wherein the anode comprises a current collector, and a catalyst layer provided on the current collector,
the catalyst layer has a porosity in a range of 20 to 65%, a volume of pores of which diameter ranges from 50 to 800 nm is 30% or more of a pore volume of the catalyst layer,
the catalyst layer has a pore diameter distribution having a peak in a range of 100 to 800 nm, and
the catalyst layer comprises fibrous supported catalysts and granular supported catalysts, the fibrous supported catalysts contain carbon nanofibers having a herringbone or platelet structure, and catalyst particles carried on the carbon nanofibers, and the granular supported catalysts contain carbon black particles and catalyst particles carried on the carbon black particles.

15. The membrane electrode assembly for liquid fuel cell according to claim 14, wherein the porosity is 30 to 55%, the volume of pores of which diameter ranges from 50 to 800 nm is 50% or more of the pore volume of the catalyst layer, and the peak of the pore diameter distribution is in a range of 100 to 600 nm.

16. A liquid fuel cell comprising an anode, a cathode, a proton conductive layer provided between the anode and the cathode, and a liquid fuel to be supplied to the anode,
wherein the anode comprises a current collector, and a catalyst layer provided on the current collector,
the catalyst layer has a porosity in a range of 20 to 65%, a volume of pores of which diameter ranges from 50 to 800 nm is 30% or more of a pore volume of the catalyst layer,
the catalyst layer has a pore diameter distribution having a peak in a range of 100 to 800 nm, and
the catalyst layer comprises fibrous supported catalysts and granular supported catalysts, the fibrous supported catalysts contain carbon nanofibers having a herringbone or platelet structure, and catalyst particles carried on the carbon nanofibers, and the granular supported catalysts contain carbon black particles and catalyst particles carried on the carbon black particles.

17. The liquid fuel cell according to claim 16, wherein the liquid fuel contains methanol and water.

18. The liquid fuel cell according to claim 16, wherein the porosity is 30 to 55%, the volume of pores of which diameter ranges from 50 to 800 nm is 50% or more of the pore volume of the catalyst layer, and the peak of the pore diameter distribution is in a range of 100 to 600 nm.

19. The liquid fuel cell according to claim 16, wherein an average diameter of the fibrous supported catalysts are in a range of 80 to 500 nm, and an average primary particle diameter of the granular supported catalysts are not more than half of the average diameter of the fibrous supported catalysts,
a specific surface area of the carbon nanofibers is in a range of 100 to 500 m²/g, and a pore volume of the carbon nanofibers is in a range of 0.15 to 0.6 cc/g, and
a specific surface area of the carbon black particles is in a range of 20 to 800 m²/g, and a dibuthyl phthalate absorption value of the carbon black particles is in a range of 15 to 500 ml/100 g.
